(19) United States
(12) Patent Application Publication
(10) Pub. No.: US 2011/0139536 A1
(43) Pub. Date: Jun. 16, 2011

(54) HYDROSTATIC DRIVE FOR A STEERING SYSTEM

(75) Inventors: Dennis Kontner, Esslingen-Zeil (DE); Alexander Kiforiux, Ebersbach An Der Fils (DE)

(73) Assignee: Thyssen Krupp Presta AG, Eschen (LI)

(21) Appl. No.: 13/059,149

(22) PCT Filed: Sep. 21, 2009
(86) PCT No.: PCT/EP09/06795

§ 371 Date: Feb. 15, 2011

(30) Foreign Application Priority Data
Oct. 9, 2008 (DE) 10 12008 050595.1

(51) Int. Cl. B62D 5/06; B62D 3/12; B62D 5/04

(52) U.S. Cl. 180/428

(57) ABSTRACT

The invention relates to a rack-and-pinion power steering system for motor vehicles, with a steering housing, in which a gear rack (1) is mounted such as to be longitudinally displaceable, and with a gear system for converting a rotational movement of a servomotor into a longitudinal movement of the gear rack (1), with which the gear system for converting a rotational movement into a longitudinal movement is a hydrostatic spindle drive with a nut (3).

The present invention relates to a motor vehicle power steering system with the features of the preamble to Claim 1.

Such steering systems are known from the prior art, such as from DE 10 2006 053 244 A1. These rack-and-pinion steering systems with electrical power assistance have an elongated steering housing that is arranged transversely to the direction of travel and is tubular in shape, in which a gear rack is mounted such as to be displaceable in a longitudinal direction. The gear rack is in turn connected by track rods to the steered wheels of the vehicle, such that a linear movement in the direction of the longitudinal axis of the gear rack leads to a pivoting movement of the steered wheels.

If a rotary drive is used, such as an electric motor, a gear system must be provided, which converts the rotational movement into a linear movement. With the generic prior art, this is a spindle drive with a recirculating ball gear mechanism, which is provided with a ball nut arranged coaxially to the gear rack. The ball nut is driven by an electric motor, directly, via a tooth arrangement, or by a belt drive. A compatible thread on the gear rack then incurs the corresponding linear movement of the gear rack in response to a rotary movement of the ball nut. The recirculating ball screw is low in friction and of low noise. It is, however, only capable of being subjected to a limited load. For heavier vehicles, such as light goods vehicles, this technique can therefore only be used to a limited degree.

It is therefore the object of the present invention to provide a rack-and-pinion steering arrangement with a gearing system capable of being subjected to high loading.

This object is achieved by a rack-and-pinion steering arrangement with the features of Claim 1.

Because the gearing system for converting a rotational movement into a linear movement is a hydrostatic spindle drive, the thrust force of the gear rack which can be created is substantially higher than with a recirculating ball screw of the same size or weight. The hydrostatic linear drive is extremely low in wear, low in noise, and low in friction. If a hollow shaft motor is provided as the drive, the hydrostatic nut can be driven directly. This drive, too, is particularly low in noise. Provision can also be made for the motor revolution speed to be adjusted by means of a gear stage to the revolution speed of the thread drive. Preferably, in this situation a belt drive is used, which together with the hydrostatic gear system forms a particularly low-noise and low-wear drive. Provision can also be made for a spur gear arrangement, since this, by contrast with a belt drive, imposes only a slight load on the nut in the radial direction.

An exemplary embodiment of the present invention is described hereinafter in greater detail on the basis of the drawing. What is shown is:

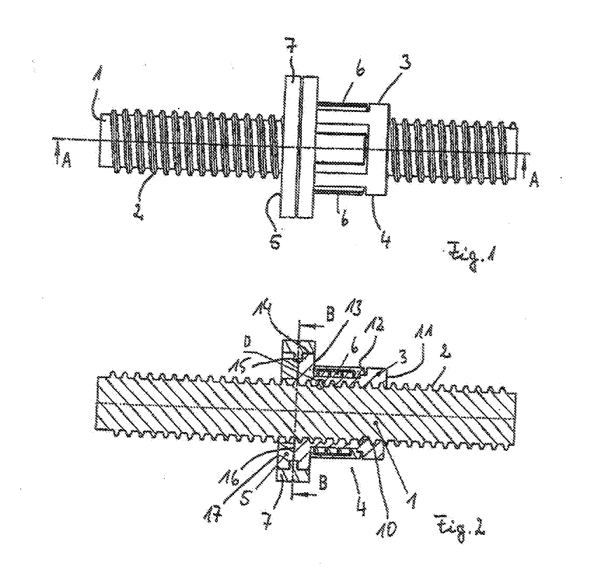

FIG. 1: The linear drive part of a rack-and-pinion steering system according to the invention, in a side view;

FIG. 2: The drive from FIG. 1 in a longitudinal section along the line A-A;

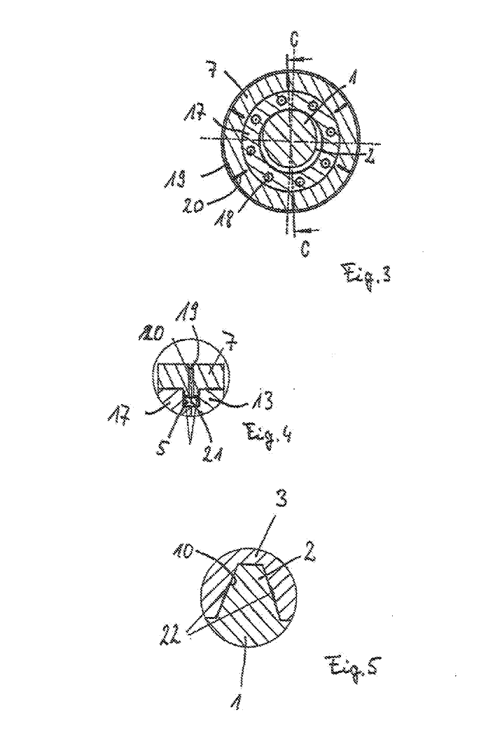

FIG. 3: A cross-section through the drive nut and the gear rack along the line B-B from FIG. 2;

FIG. 4: A detail of the drive nut from FIG. 3 in the cross-section C-C; and

FIG. 5: The detail D from FIG. 2.

FIG. 1 shows a section of a gear rack 1, which is provided with a thread 2. The thread 2 has thread pitches that are trapezoidal in cross-section. Other cross-section forms of the thread are also possible, however, such as rectangular thread pitches.

A nut 3 meshes with the thread 2. The gear rack, which cannot be rotated and is mounted in a steering housing (not shown) such as to be displaceable in the direction of its longitudinal axis, is moved when the nut 3 moves in its axial direction, since the nut is likewise mounted in a rotatable manner in the steering housing. Accordingly, this involves a gear system that converts a rotational movement of the nut 3 into an axial movement of the gear rack 1.

The nut 3 has in general a first section 4 with a relatively small diameter, and a second section 5 with a relatively large diameter. In the section 4 are four oil pressure regulators 6, arranged uniformly on the essentially circular-cylindrical outer circumferential surface. In the section 5 a bearing outer ring 7 is provided, which serves to mount the nut 3 in the steering housing.

FIG. 2 shows the arrangement described in a longitudinal section along the line A-A from FIG. 1. The same structural elements bear the same reference numbers.

The nut 3 is provided on its inner side with a trapezoidal thread 10, which is compatible with the outer thread 2 of the gear rack 1. The nut 3 is further designed as one piece, extending from a free shoulder 11 as far as the line BB. Arranged in the section 4 are a total of four recesses 12, in which the oil pressure regulators 6 are located. Adjacent to the oil pressure regulators 6, the recesses 12 merge at right angles into a ring-shaped collar 13. The collar 13 faces radially outwards and lies in a plane perpendicular to the axis of symmetry of the gear rack 1. An outer cylindrical circumferential surface 14 joins the collar 13. This in turn merges in a rebound 15 into a flange surface 16 arranged parallel to the collar 13. The flange surface 16 in the representation in FIG. 2 coincides with the line B-B. Finally, a ring 17 is set on the face side onto the flange surface 16. The ring 17 is a mirror image in its radial outer area of the collar 13, which forms the circumferential surface 14 and the rebound 15. In the interior the ring 17 is provided with a clear opening, which is sufficiently large to allow the gear rack 1 with the tooth arrangement 2 to be pushed through it freely.

The circumferential surface 14, the rebound 15, and the mirror-image counter piece of the ring 17 form an approximately T-shaped receptacle for the bearing outer ring 7, which is approximately T-shaped in cross-section.

The gear rack 1 with the thread 2 is surrounded in ring fashion by the ring 17. Screws 18 pass through the ring 17 in an axially parallel fashion, and serve to secure it in the flange surface 14 of the nut 3. The bearing outer ring 7 is located concentrically on the ring 17. It is provided with a circumferential feed channel 19, from which a total of six holes 20 run onto the separation plane between the flange surface 14 and the ring 17. The nut 3 with the ring 17 secured to it can be rotated in relation to the bearing outer ring 7.

A partial longitudinal section along the line C-C is shown in FIG. 4. Here, the area between the bearing outer ring 7, the collar 13, and the ring 17 are shown enlarged. The channel 19 is designed in the form of a groove embossed on the circumferential side while the hole 20 runs in the radial direction of the bearing outer ring 7. A channel 21 is formed between the bearing outer ring 7, the collar 13, and the ring 17 in the area of the rebounds 15, said channel being capable of conducting hydraulic fluid or another fluid under pressure.

Finally, FIG. 5 shows the detail D from FIG. 2. The gear rack 1 with the trapezoidal tooth arrangement 2 engages into the compatible thread 10 of the nut 3. Recesses 22 are formed on the adjacent flanks of the trapezoidal thread, which recesses 22 in this case are formed into the flank of the nut 3. The recesses 22 function as oil pockets, which accommodate and retain hydraulic fluid.

In operation, the bearing outer ring 7 is mounted in a steering housing. The gear rack 1 is mounted such as to be displaceable in the axial direction in at least one further bearing (not shown). The nut 3 is connected in a rotatable manner with a drive. A hydraulic fluid is fed in frofn the outside via the circumferential groove 19, and enters the intermediate space 21 under pressure through the channels 20. From there, the hydraulic fluid is fed onwards via the pressure regulators 6 into the thread tooth arrangement 2, 10. There the hydraulic fluid enters the recesses 22. A hydrostatic film is formed, which carries and bears both the nut 3 and the ring 17 in the bearing outer ring 7, as well as bearing the nut 3 in relation to the gear rack 1. The film of hydraulic fluid under pressure carries the gear rack 1 and separates the nut 3 from it. Since there is no direct metallic contact between the nut 3 and the gear rack 1, when a movement occurs there is only very little noise, if any. The hydrostatic nut 3 which rotates in operation is provided by the bearing outer ring 7 with an integrated hydrostatic bearing, and requires an oil infeed only at this point.

The threaded spindle practically floats on a hydrostatic oil film.

The regulators 6 control the oil flows required during movement, such that the oil film thickness can be kept almost constant regardless of the speed and loading. The hydrostatic nut 3, rendered backlash-free in this manner, is very rigid and nevertheless presents only very slight friction. The positioning precision is markedly good in particular due also to the low friction, and is dependent only on the sensors used and the control system. In respect of dynamic loading in operation, the thread drive represented functions like a shock absorber with very good damping. It runs free of noise, and, in particular, does not cause any vibrations, such as are known with recirculating ball screws. The hydrostatic nut 3 is capable, thanks to its high rigidity, of bearing the gear rack 1 with only one bearing (bearing outer ring 7). All the hydraulic inlets and outlets that are required for operation can be guided in the outer surface of the bearing outer ring 7.

The steering system described can preferably be used for heavier motor vehicles, for example for large cars or light goods vehicles. It is characterised by high rigidity, high positioning precision, and low noise generation. This provides advantages with regard to the driving behaviour and comfort, in particular with large cars. The transferable forces and the sustained performance of the drive are greater than with recirculating ball screws, such that this steering system also comes into consideration for applications in heavy goods vehicles as well. In comparison with the known hydraulic power-steering systems, the effort and expenditure for the hydraulics is limited to relatively small components operating at low pressure, wherein these need only provide for the bearing of the nut 3. Control valves and large external hydraulic pumps can be done away with, by contrast with the known hydraulic power steering systems. Even if hydraulic components cannot be entirely done away with, as is possible, for example, with electrical power steering systems with a ball recirculating screw, an advantage is nevertheless achieved with regard to installation space and manufacturing costs.

### REFERENCE FIGURES LIST

1. Gear rack
2. Thread
3. Nut
4. First section
5. Second section
6. Oil pressure regulators
7. Bearing outer ring
10. Trapezoidal thread
11. Free shoulder
12. Recesses
13. Collar
14. Circumferential surface
15. Rebound
16. Flange surface
17. Ring
18. Screws
19. Feed channel
20. Hole
21. Channel
22. Recesses

1. A rack-and-pinion power steering system for motor vehicles, with a steering housing, in which a gear rack is mounted such as to be longitudinally displaceable, and with a gear system for converting a rotational movement of a servomotor into a longitudinal movement of the gear rack, wherein the gear system for converting a rotational movement into a longitudinal movement is a hydrostatic spindle drive with a nut.

2. The rack-and-pinion power steering system according to claim 1, wherein a hollow shaft motor is provided as the drive motor for the nut.

3. The rack-and-pinion steering system according to claim 1, wherein the drive motor is coupled to the nut by means of a gear stage.

4. The rack-and-pinion power steering system according to claim 1, wherein the gear stage is a belt drive.

5. The rack-and-pinion power steering system according to claim 1, wherein the gear stage is a spur gear arrangement.
